(19) United States
(12) Patent Application Publication
(10) Pub. No.: US 2015/0123359 A1
(43) Pub. Date: May 7, 2015

(54) SUSPENSION STRUT EXTENSION AND ANGLE CORRECTION DEVICE

(71) Applicant: ReadyLIFT Suspension, Inc., Henderson, NV (US)

(72) Inventors: Jeffery Allen Yoder, El Cajon, CA (US); Scott Evan Poncher, Henderson, NV (US)

(21) Appl. No.: 14/532,783

(22) Filed: Nov. 4, 2014

Related U.S. Application Data
(60) Provisional application No. 61/899,766, filed on Nov. 4, 2013.

(51) Int. Cl. B60G 17/00

(52) U.S. Cl. CPC B60G 17/00
USPC 280/6.157

(57) ABSTRACT

A system and method for modifying a ride height of a vehicle is disclosed. A vehicle lift system has a first suspension strut extension device, having an extension member fixed between an upper plate mount and a lower plate mount. The upper plate mount is secured to a top edge of the extension member at an angle relative to the lower plate mount such that the upper plate mount and the lower plate mount are not parallel. The extension member is angled in a first direction according to a first angle relative to the x-z plane. And the extension member is angled in a second direction according to a second angle relative to the y-z plane.

### CROSS-REFERENCE TO RELATED APPLICATIONS

This application claims priority to U.S. Provisional Application No. 61/899,766, filed Nov. 4, 2013, the disclosure of which is hereby incorporated by reference herein in its entirety.

### FIELD

The present invention relates generally to vehicular suspension systems, and more specifically in some embodiments to a device which supports a suspension strut assembly in vehicular suspension systems.

### BACKGROUND

Factory strut-style suspension systems (spring over shock absorber systems) may typically be connected at the top to the chassis of a vehicle via a bearing or bushing plate and at the bottom to the steering knuckle or lower control arms via a bolting action. The suspension system is typically located on the outboard side of the chassis, and inboard from the wheel on the bottom of the control arm or steering knuckle mount. The result is that the strut must be mounted at an angle with the lower mount moving outboard of the upper mount. The angle at which the suspension system is mounted at the top and lower mounts may be specifically calculated to protect the strut from premature wear and/or failure of the system.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented below.

In one embodiment a method for modifying a ride height of a vehicle is disclosed. The vehicle having a suspension assembly secured to a vehicle chassis mount, and the suspension assembly is at a factory mounting angle relative to a vertical plane. The method includes the steps of: (1) removing a top face of the suspension assembly from the vehicle chassis mount; and (2) providing a suspension strut extension device. The extension strut device has an upper plate mount; a lower plate mount; and an extension member secured between the upper plate mount and the lower plate mount. The extension member is angled such that the upper mount is offset relative to a center point of the lower mount according to a first angle and off-axis from the center point of the lower mount according to a second angle. The method further includes the step of (3) securing the upper plate mount to the vehicle chassis mount and the lower plate mount to the top face of the suspension assembly, thereby resulting in an extended suspension assembly. A mounting angle of the extended suspension assembly is substantially the same as the factory mounting angle.

In another embodiment, a vehicle lift system has a first suspension strut extension device having an extension member fixed between an upper plate mount and a lower plate mount. The upper plate mount is secured to a top edge of the extension member at an angle relative to the lower plate mount such that the upper plate mount and the lower plate mount are not parallel. The extension member is angled in a first direction according to a first angle relative to the x-z plane. And the extension member is angled in a second direction according to a second angle relative to the y-z plane.

In still another embodiment, a suspension strut extension device has an upper plate mount having a first angle, and a lower plate mount, wherein the upper plate mount is secured to the lower plate mount at a position offset from a center point of the lower plate mount.

### BRIEF DESCRIPTION OF THE DRAWINGS

FIG. 1 is a perspective view of a suspension strut extension and angle correction device according to one embodiment.

FIG. 2 is a front view of the suspension strut extension and angle correction device of FIG. 1.

FIG. 3 is a side view of the suspension strut extension and angle correction device of FIG. 1.

FIG. 4 is a top view of the suspension strut extension and angle correction device of FIG. 1.

FIG. 5 is a perspective view of a suspension strut extension and angle correction device according to another embodiment.

FIG. 6 is a side view of the suspension strut extension and angle correction device of FIG. 5.

FIG. 7 is a side view of the suspension strut extension and angle correction device of FIG. 5.

FIG. 8 is a top view of the suspension strut extension and angle correction device of FIG. 5.

FIG. 9 is a perspective view of a suspension strut extension and angle correction device according to still another embodiment.

FIG. 10 is a side view of the embodiment of FIG. 9.

FIG. 11 is a bottom view of the embodiment of FIG. 9.

FIG. 12 is a top view of the embodiment of FIG. 9.

FIG. 13 is a perspective view of a suspension strut extension and angle correction device and a factory suspension assembly according to yet another embodiment.

FIG. 14 is a perspective view of a suspension strut extension and angle correction device installed onto a factory suspension assembly to form a spacer/strut assembly.

FIG. 15 is another perspective view of a suspension strut extension and angle correction device installed between a factory suspension assembly and a vehicle chassis.

FIG. 16 is a close up view of a suspension strut extension and angle correction device installed between a factory suspension assembly and a vehicle chassis.

### DETAILED DESCRIPTION

A vehicle from a factory comes equipped with a suspension system for allowing relative motion between the vehicle and its wheels. The suspension system has both an upper mount and a lower mount. The lower mount is secured to the steering knuckle or lower control arms. To prevent excessive wear and tear on the suspension system, the upper mount of the suspension system may be secured to a vehicle chassis mount. The suspension system may be held at an angle relative to the vertical axis once secured to the chassis mount; this angle may be known as the factory mounting angle (or the angle plane of the lower mount relative to the upper mount).

Modifying the vehicle suspension system ride height changes the angle plane of the lower mount relative to the upper mount. This change in the angle plane causes misalignment of the suspension system, which may result in high side load forces to various components of the suspension system (e.g., strut shaft and rod guide, mounting bushings, and bearing plates). These forces may cause premature wear of the suspension system, deteriorated ride quality, and ultimately premature failure of the system.

Several solutions have been proposed. First, the lower mounting position of the suspension assembly may be moved out. However, this would increase vehicle track width and would create other issues related to the suspension geometry and performance.

A second solution may be to lower the strut assembly attachment point straight down from its standard position. While this solution may decrease high side load forces caused by changes in the angle plane, it would also create additional problems, including inadequate clearance with the factory vehicle frame. Typical vehicle frame members feature a recession in the frame so that the upper strut mount and spring plate clear the frame, with the frame widening after the recession. Lowering the strut assembly attachment point would thus pose a clearance problem when lowering the strut assembly straight down.

A third possible solution may include relocating the strut assembly unit by moving it up or down via a spacer in order to maintain a length necessary to connect with the factory vehicular attachment points at the frame (upper mount) and at the control arm or steering knuckle (lower mount). But, when the strut assembly unit is relocated in a direct linear plane in association with the factory angle, misalignment with the factory mounting points occurs.

Devices for correcting the angle of a suspension system when the vehicle ride height is modified are described herein. In one embodiment, a suspension strut extension and angle correction device may address the above-identified problems by providing the additional length required to safely and properly secure a suspension assembly to factory mounting attachment points and providing correction of the mounting angle of an upper mount to the chassis to prevent premature wear and/or failure of the suspension assembly.

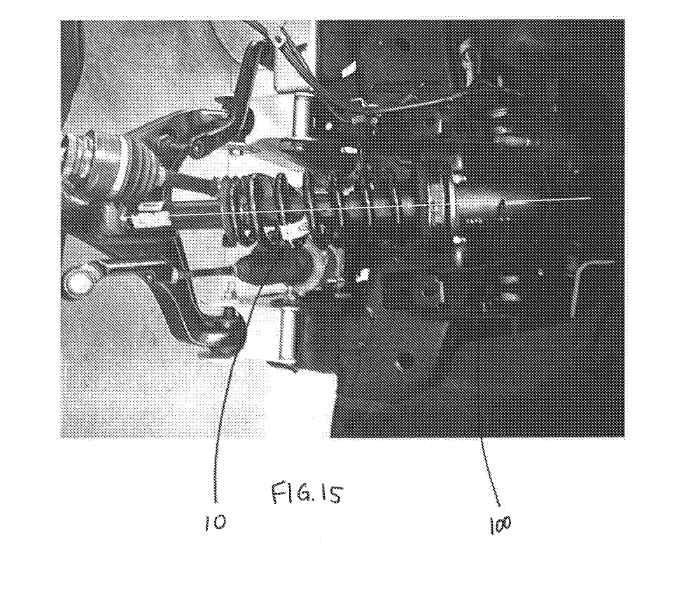

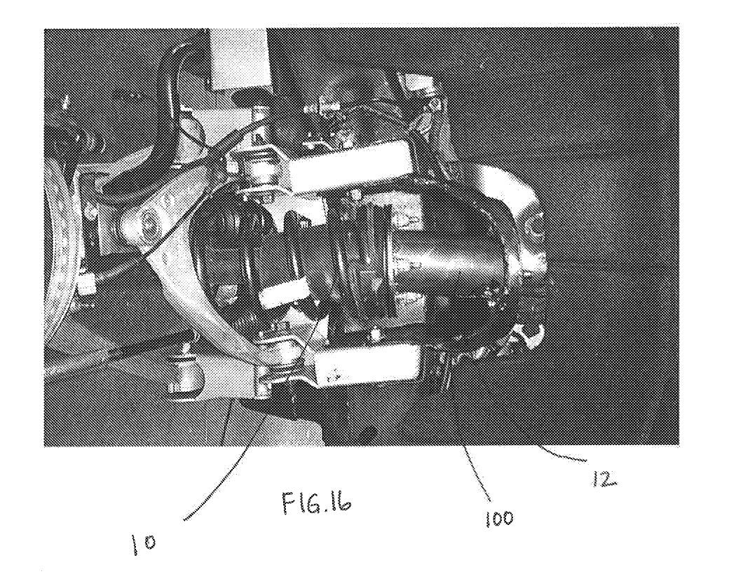

The suspension strut extension and angle correction device 100 (spacer 100) may extend between the factory suspension assembly 10 (FIG. 13) and the chassis for raising the ride height of a vehicle. With reference to the figures, the spacer 100 may include an upper plate mount 105, a lower plate mount 110, and an extension member 115. The spacer 100 and suspension assembly 10 are hereinafter collectively referred to as an extended suspension assembly 15 (FIG. 14).

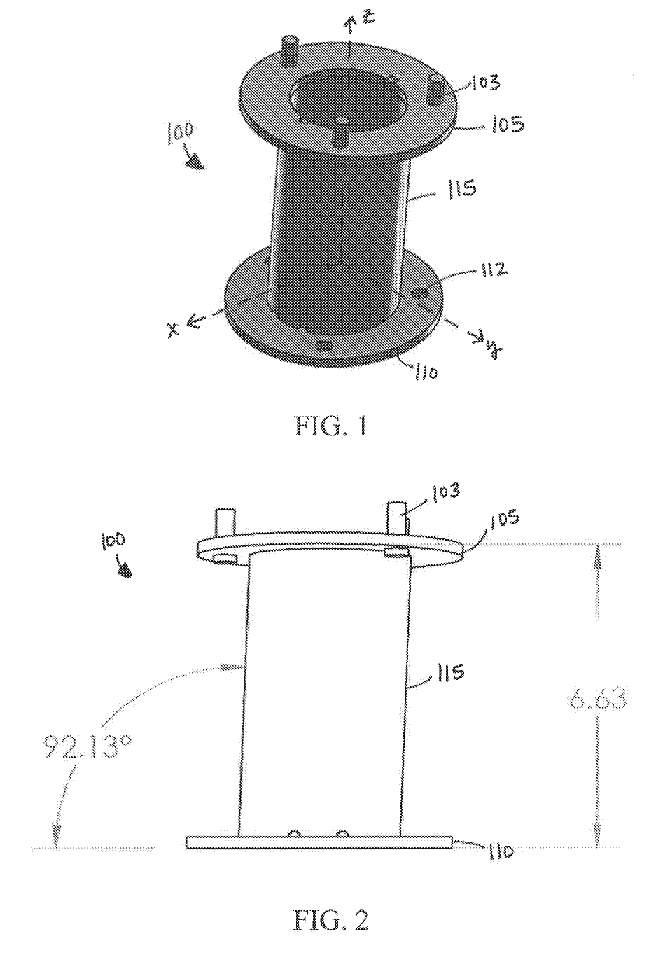

The upper mount 105 of the spacer 100 may be a mounting plate for securing the extended suspension assembly 15 to a chassis 12 (FIG. 16) at an upper frame mount (not shown). The lower mount 110 may similarly be a mounting plate for securing the spacer 100 to a top face 14 of the factory suspension strut assembly 10 (shown in FIG. 13). The upper mount 105 may be provided with means for securing the mount 105 to the chassis. For example and as shown in FIG. 1, the upper mount 105 may have several bolts 103 which may be received by the upper frame mount of the chassis and secured into place with nuts (not shown). The lower mount 110 may also be provided with means for securing the mount 110 to the factory suspension assembly 10. For example and as shown in FIG. 1, the lower mount 110 may have receiving holes 112 for receiving bolts on the top face 14 of the factory suspension assembly 10, which may also be secured with nuts. FIG. 14 shows the lower mount 115 of the spacer 100 attached to the top face 14 of the factory suspension assembly 10.

It shall be recognized that alternative means (e.g., rivets, fasteners, screws, grommets, etc.) for securing the upper mount 105 to the upper frame mount of the chassis and the lower mount 110 to the factory suspension assembly 10 may also be acceptable.

The extension member 115 may be a cylindrical tube extending between the upper mount 105 and the lower mount 110. The top edge 107 of the extension member 115 may be machined at an angle relative to the x-y plane, and the angle may be opposite the angle of the vehicle chassis mount. For example, the top edge 107 may be machined at a first angle opposing the angle of the upper frame mount. Additionally, the extension member 115 may be machined at a first angle relative to an x-z and a second angle relative to a y-z plane. In other words, the extension member 115 may be machined such that when the upper mount 105 is secured to the extension member 115, the upper mount 105 is offset and off-axis from a center position of the lower mount 110.

The specific configuration of the various angles of the spacer 100 allow for the spacer 100 to correct for the misalignment of the factory suspension assembly 10 resulting from modification of the vehicle ride height. In other words, a mounting angle of the extended suspension assembly 15 relative to the vertical axis is substantially the same as the factory mounting angle (e.g., within about a 10% threshold) when the extended suspension assembly 15 is installed on the vehicle chassis.

As may be understood by the examples provided below, the angles at which the upper mount 105 may be offset and off-axis from a center position of the lower mount 110 may vary depending on the specifications of a particular vehicle. The upper mount 105 may be offset relative to the center point of the lower mount 110 according to a first angle, and off-axis relative to the center point of the lower mount 110 according to a second angle. The first and second angles may not be identical.

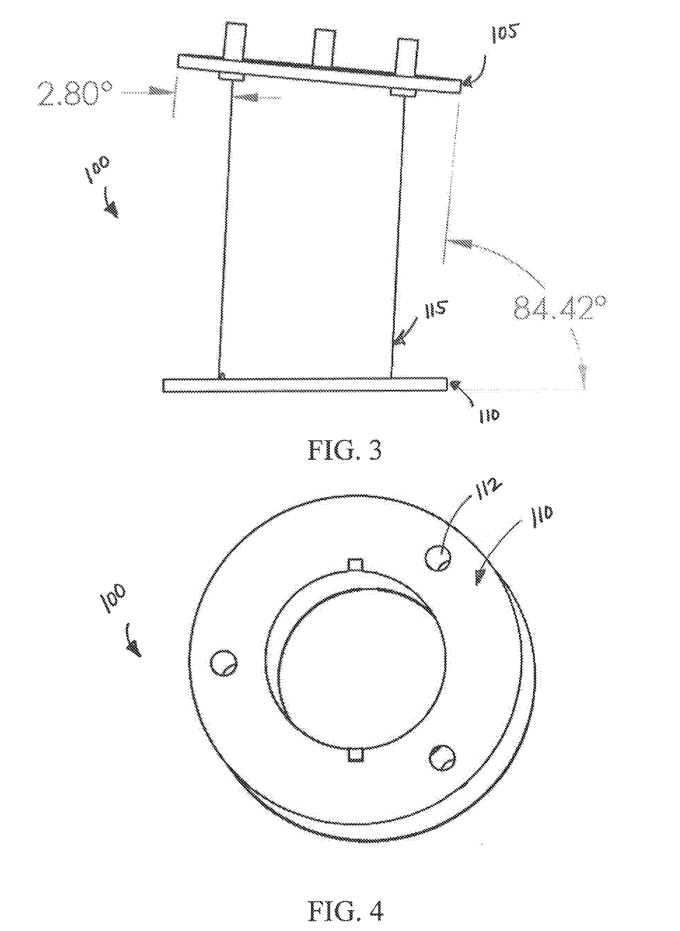

By way of example, FIGS. 1-4 show an embodiment of a spacer 100 for use with a Ford F-150 pickup truck. FIG. 1 shows the spacer 100 according to one non-limiting orientation. The angle of the top edge 107 of the extension member 115 relative to the x-y plane may be approximately 2.80°. The angle of the extension member 115 relative to the y-z plane may be approximately 92.13°. And the extension member 115 may also be angled relative to the x-z plane such that the angle of the upper mount 105 relative to the x-y plane is about 84.42°.

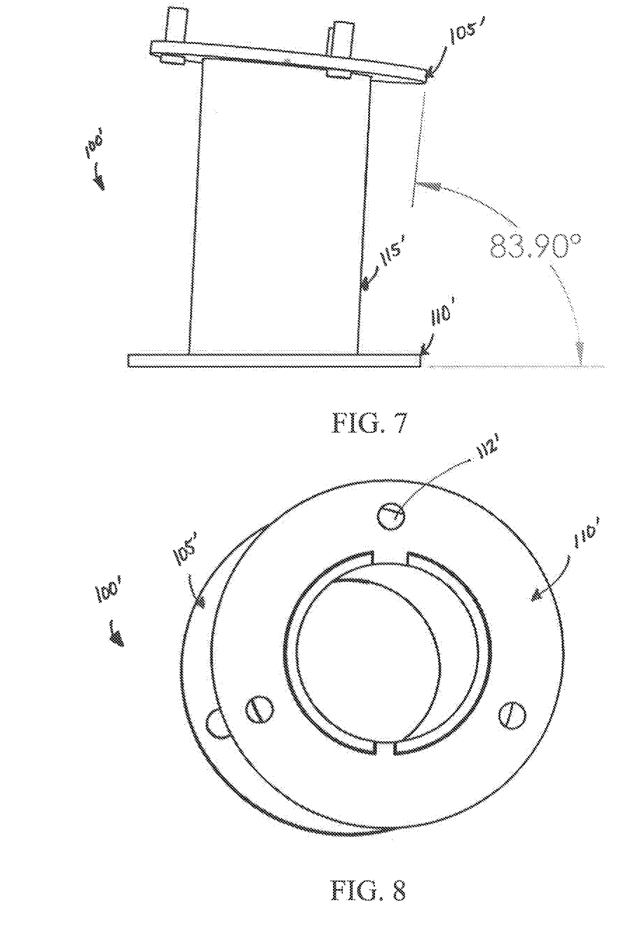

FIGS. 6-8 show another embodiment of a spacer 100′ for use with a General Motors 1500 pickup truck which is substantially similar to that described above with reference to spacer 100, except as specifically shown or described. Here, the angle of the extension member 115 relative to the y-z plane may be approximately 95.99°, and the extension member 115 may be further angled relative to the x-z plane such that the angle of the upper mount 105′ relative to the x-y plane is approximately 83.90°.

Other makes and models of vehicles may have alternative specifications, requiring adjustment of the various angles of the spacer 100.

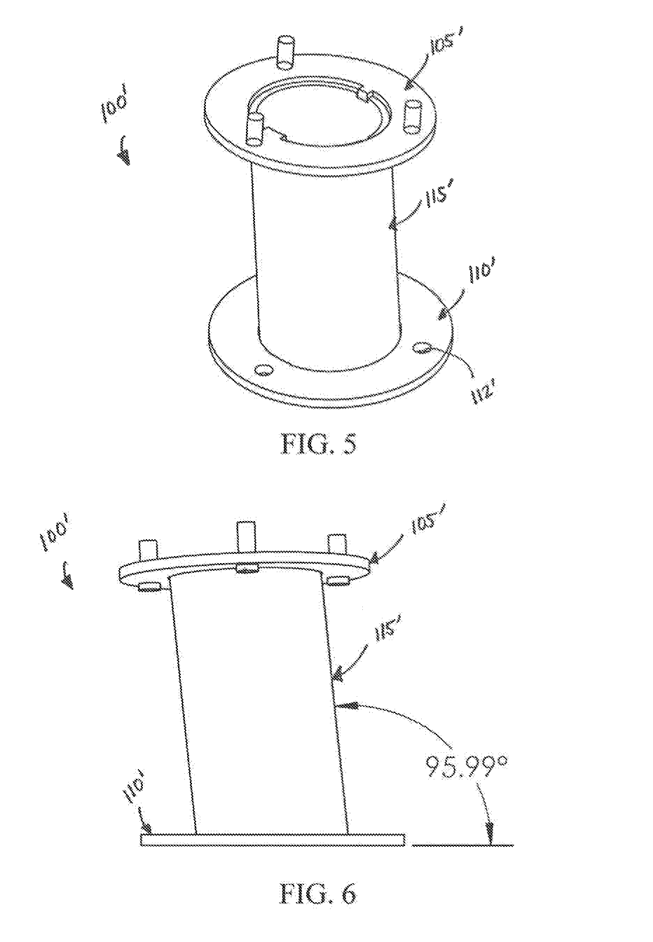

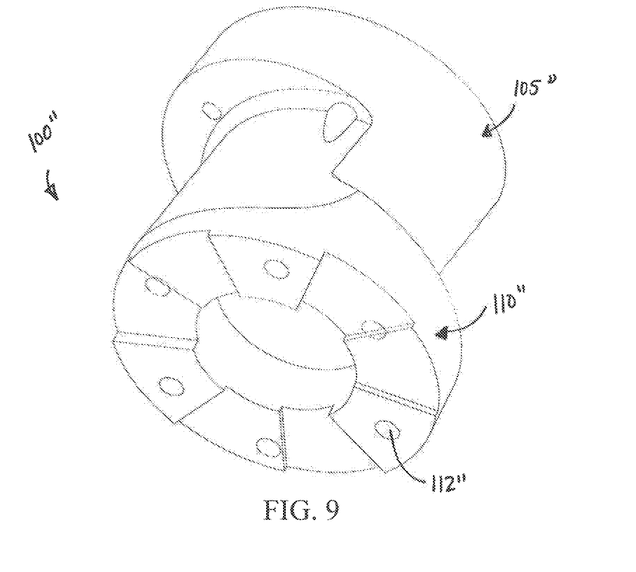

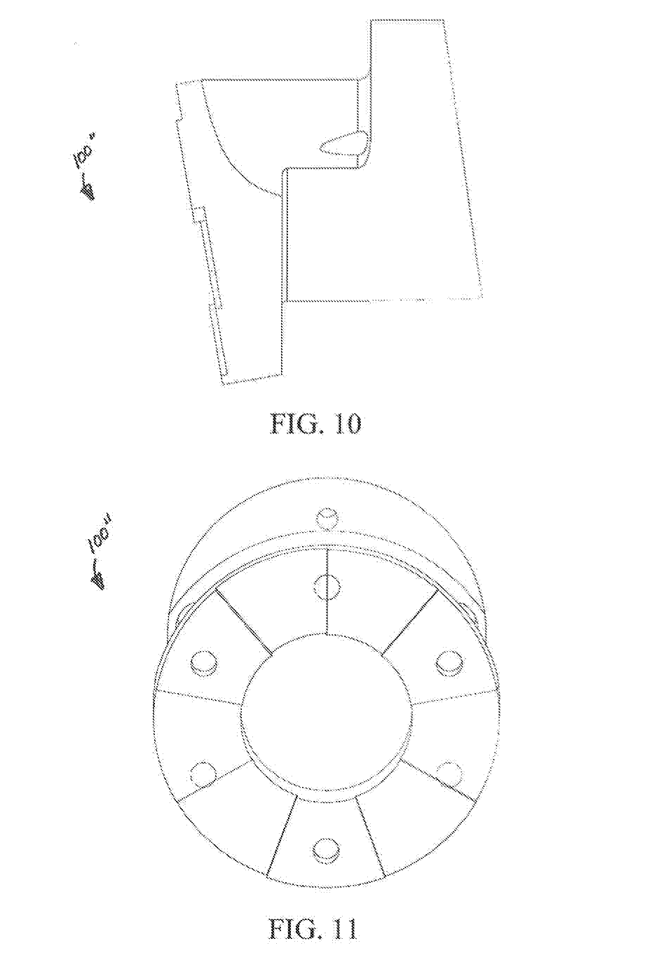

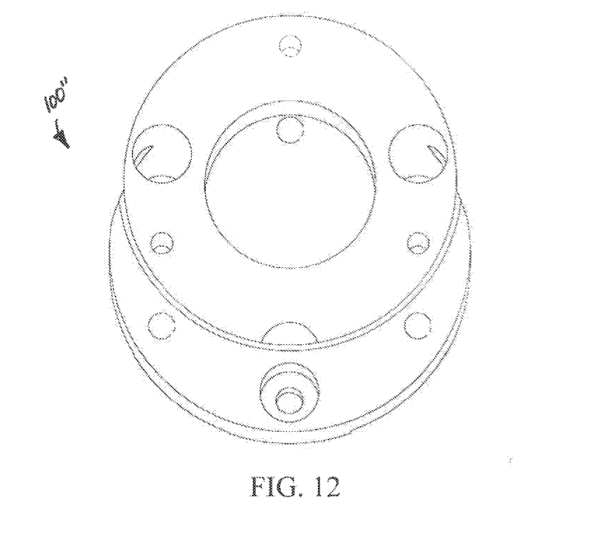

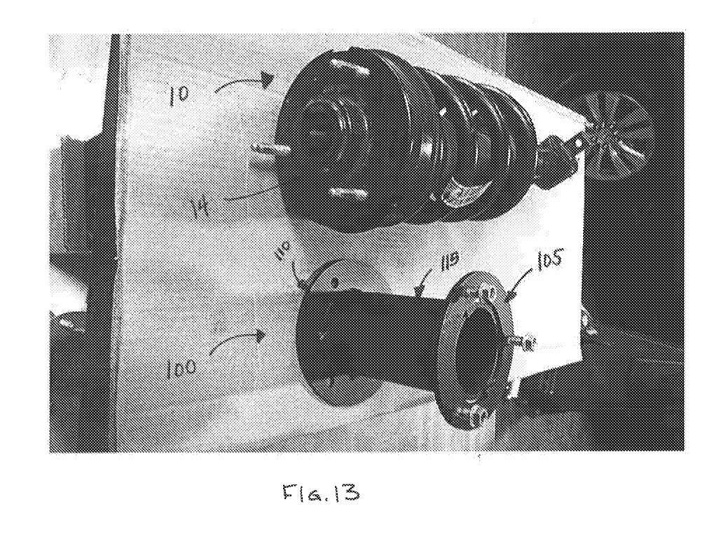

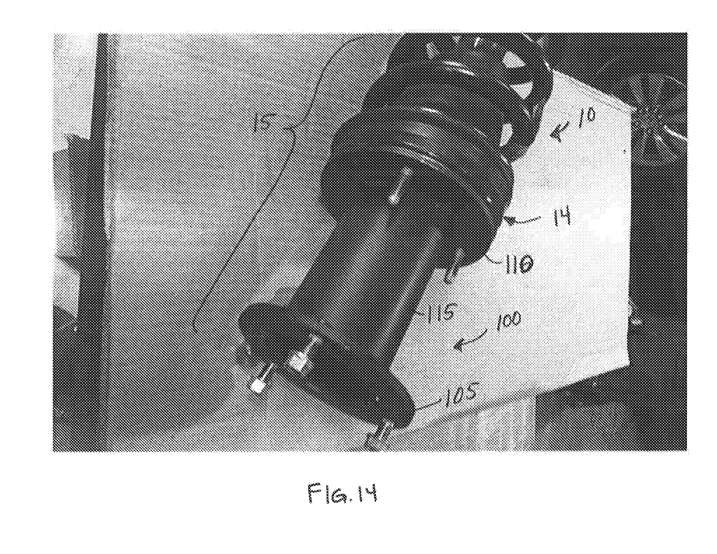

FIG. 9 shows another embodiment of a spacer 110″ for modifying the vehicle ride height and correcting the angle between the chassis and the suspension assembly 10 that is substantially similar to those shown in FIGS. 1-8, except as would be inherent or as described herein. Here, the spacer 100″ includes a lower strut mounting face 110″, mounting holes 112″, an upper strut mounting face 105″, and counter bores (not shown) that allow the factory suspension assembly 10 to be bolted to the spacer 100″. The upper mounting face 105″ may use an opposing angle face to change the directional path of the spacer 100″ so as to correct the angle of the factory suspension assembly with the spacer.

In use, the upper mount 105 of the spacer 100 may be installed to the vehicle's factory upper frame mount of the chassis, which may typically be provided at an angle for strength and geometric suspension actuation of the spring and shock absorber damping rates. The lower mount 110 of the spacer 100 may be attached to the top face 14 of the factory suspension assembly 10. The spacer 100 may be mounted to the chassis and the factory suspension assembly such that the angles of the spacer correct the misalignment of the factory suspension assembly due to modification of the vehicle ride height.

Spacers 100 may be provided on both the driver's side and the passenger's side of a vehicle for uniform lift, and the driver's side spacer 100 and the passenger's side spacer 100 may be mirror components of each other.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims. Various steps in described methods may be undertaken simultaneously or in other orders than specifically provided.

What is claimed is:

1. A method for modifying a ride height of a vehicle, the vehicle having a suspension assembly secured to a vehicle chassis mount, the suspension assembly being at a factory mounting angle relative to a vertical plane, the method comprising the steps of:
removing a top face of the suspension assembly from the vehicle chassis mount;
providing a suspension strut extension device, comprising:
an upper plate mount;
a lower plate mount; and
an extension member secured between the upper plate mount and the lower plate mount;
wherein the extension member is angled such that the upper mount is offset relative to a center point of the lower mount according to a first angle and off-axis from the center point of the lower mount according to a second angle;
securing the upper plate mount to the vehicle chassis mount and the lower plate mount to the top face of the suspension assembly, thereby resulting in an extended suspension assembly;
wherein a mounting angle of the extended suspension assembly is substantially the same as the factory mounting angle.

2. The method of claim 1, wherein the first angle and the second angle are not equal.

3. The method of claim 2, wherein a top edge of the extension member is angled according to a third angle relative to a horizontal plane such that the upper plate mount and the lower plate mount are not parallel.

4. The method of claim 3, wherein the first angle is approximately 92.13 degrees.

5. The method of claim 4, wherein the second angle is approximately 84.42 degrees.

6. The method of claim 5, wherein the third angle is approximately 2.80 degrees.

7. The method of claim 1, wherein the first angle is approximately 95.99 degrees.

8. The method of claim 7, wherein the second angle is approximately 83.90 degrees.

9. The method of claim 1, wherein the upper plate mount and the lower plate mount are fixed relative to the extension member.

10. The method of claim 9, wherein the upper plate mount and the lower plate mount are welded to the extension member.

11. The method of claim 10, wherein the upper plate mount further comprises bolts for securing the upper mount to the upper frame mount.

12. The method of claim 11, wherein the lower plate mount further comprises apertures for receiving means for fastening the lower plate mount to the top face of the suspension assembly.

13. The method of claim 1, wherein removing the suspension assembly from the vehicle results in a misalignment of the suspension assembly with the chassis, and wherein securing the suspension extension device between the suspension assembly and the vehicle chassis substantially corrects the misalignment of the suspension assembly, thereby reducing premature wear and failure of the suspension assembly.

14. A vehicle lift system, comprising:
a first suspension strut extension device, comprising an extension member fixed between an upper plate mount and a lower plate mount;
wherein:
the upper plate mount is secured to a top edge of the extension member at an angle relative to the lower plate mount such that the upper plate mount and the lower plate mount are not parallel;
the extension member is angled in a first direction according to a first angle relative to the x-z plane; and
the extension member is angled in a second direction according to a second angle relative to the y-z plane.

15. The device of claim 14, wherein the first angle and the second angle are not identical.

16. The device of claim 15, wherein the angle of the upper plate mount is opposite an angle of a corresponding vehicle chassis mount.

17. The device of claim 16, wherein the upper mount plate is secured to the upper mount of a vehicle frame and the lower mount plate is secured to a top face of a factory suspension system.

18. The device of claim 17, wherein the factory suspension system is substantially perpendicular with the ground such that side loads on the suspension system are reduced, thereby preventing premature wear and failure of the suspension system.

19. The device of claim 18, further comprising a second suspension strut extension device, the second suspension strut extension device being a mirror component of the first suspension strut extension device, wherein the first suspension strut extension device is configured for attachment to the upper mount at either the driver's side or the passenger's side, and wherein the second suspension strut extension device is configured for attachment to the upper mount at the other of the driver's side or the passenger's side.

20. A suspension strut extension device, comprising an upper plate mount having a first angle, and a lower plate mount, wherein the upper plate mount is secured to the lower plate mount at a position offset from a center point of the lower plate mount.
